(19) United States
(12) Patent Application Publication
(10) Pub. No.: US 2024/0344909 A1
(43) Pub. Date: Oct. 17, 2024

(54) METHODS AND SYSTEMS FOR ESTIMATING RESIDUAL STRESS IN OBJECT

(71) Applicant: IIDA Co., Ltd., Kanagawa (JP)

(72) Inventors: Shigeo MIYAKE, Fukushima (JP); Shuichi NOWATARI, Fukushima (JP); Hidemi HANADA, Fukushima (JP)

(73) Assignee: IIDA Co., Ltd., Kanagawa (JP)

(21) Appl. No.: 18/412,648

(22) Filed: Jan. 15, 2024

(30) Foreign Application Priority Data
Apr. 13, 2023 (JP) 2023-065567

(51) Int. Cl. G01L 1/24; G01N 21/3581

(52) U.S. Cl. CPC G01L 1/248; G01N 21/3581; G01N 2201/061

(57) ABSTRACT

An objective of the present invention is to quantitatively estimate the residual stress of an object. The present invention provides a method for estimating the residual stress of an object, the method comprising: irradiating an object with terahertz waves; measuring polarization intensity of the terahertz waves transmitted through or reflected by the object; and calculating tensile stress of the object based on the measured polarization intensity. In one embodiment, calculating the tensile stress includes calculating the tensile stress based on a relationship between polarization intensity and tensile stress derived from: a relationship between polarization intensity and tensile distance; and a relationship between tensile distance and tensile stress.

### TECHNICAL FIELD

The present invention relates to a method and the like for estimating residual stress in an object (for example, a molded article, more specifically, a resin molded article).

### BACKGROUND ART

Molded articles, such as resin molded articles, have been conventionally processed into products having prescribed dimensions by machining or the like. The molded articles that have been finally processed to prescribed dimensions, however, may be problematic because, if residual stress exists in such molded articles, the shape of the molded articles may change over time due to the residual stress, and deviate from the prescribed dimensions by the time of actual use.

Techniques for analyzing the internal state of a substance using terahertz waves have been recently developed (Patent Literature 1).

### CITATION LIST

### [Patent Literature]

[PTL 1] WO 2011/059044

### SUMMARY OF INVENTION

### Technical Problem

In the conventional analysis of the internal state of a substance using terahertz waves, however, although it has been possible to qualitatively analyze the state of internal defects and strains, it has not been possible to quantitatively estimate the residual stress.

An objective of the present invention is to provide a method and the like for estimating the residual stress of an object, capable of quantitatively estimating the residual stress of the object.

### Solution to Problem

The Inventors of the present invention have found for the first time that there is a correlation between the polarization intensity and the tensile stress (and therefore residual stress), on the basis of the knowledge that the polarization intensity after terahertz waves have transmitted through the molded article fluctuates due to the internal structure of the molded article.

The present invention provides, for example, the following items.

### (Item 1)

A method for estimating residual stress of an object, the method comprising:
irradiating an object with terahertz waves;
measuring polarization intensity of the terahertz waves transmitted through or reflected by the object; and
calculating tensile stress of the object based on the measured polarization intensity.

### (Item 2)

The method according to the item above, wherein calculating the tensile stress comprises calculating the tensile stress based on a relationship between polarization intensity and tensile stress derived from: a relationship between polarization intensity and tensile distance; and a relationship between tensile distance and tensile stress.

### (Item 3)

The method according to any one of the items above, wherein the relationship between polarization intensity and tensile stress is acquired by:
acquiring the relationship between polarization intensity and tensile distance;
acquiring the relationship between tensile distance and tensile stress; and
combining the relationship between polarization intensity and tensile distance with the relationship between tensile distance and tensile stress, via the tensile distance, to derive the relationship between polarization intensity and tensile stress.

### (Item 4)

The method according to any one of the items above, wherein acquiring the relationship between polarization intensity and tensile distance comprises:
fixing an orientation around an optical axis and irradiating the object with the terahertz waves under various tensile distance conditions;
measuring polarization intensity under the various tensile distance conditions; and
acquiring a relationship between the polarization intensity and a tensile distance associated with the polarization intensity.

### (Item 5)

The method according any one of the items above, wherein calculating the tensile stress comprises:
determining whether the object is in an elastic region or in a plastic region based on the polarization intensity;
when the object is in the elastic region, calculating the tensile stress based on a relationship between polarization intensity and tensile stress of the object in the elastic region; and
when the object is in the plastic region, calculating the tensile stress based on a relationship between polarization intensity and tensile stress of the object in the plastic region.

### (Item 6)

The method according to any one of the items above, wherein the object includes a resin.

### (Item 7)

The method according to any one of the items above, wherein the resin includes polytetrafluoroethylene (PTFE).

### (Item 8)

A system for estimating residual stress of an object, the system comprising:
means for irradiating an object with terahertz waves;
means for measuring polarization intensity of the terahertz waves transmitted through or reflected by the object; and
means for calculating tensile stress of the object based on the measured polarization intensity.

### (Item 8A)

The system according to item 8, comprising a feature according to any one of the items above.

### (Item 9)

A computer system for estimating residual stress of an object, the computer system comprising:
acquisition means for acquiring polarization intensity when terahertz waves with which an object has been irradiated are transmitted through or reflected by the object; and
calculation means for calculating tensile stress of the object based on the acquired polarization intensity.

### (Item 9A)

The computer system according to item 9, comprising a feature according to any one of the items above.

### (Item 10)

A method for estimating residual stress of an object, the method comprising:
acquiring polarization intensity when terahertz waves with which an object has been irradiated are transmitted through or reflected by the object; and
calculating tensile stress of the object based on the acquired polarization intensity.

### (Item 10A)

The method according to item 10, comprising a feature according to any one of the items above.

### (Item 11)

A program for estimating residual stress of an object, the program being executed by a computer system comprising a processor, the program causing the processor to execute processing comprising:
acquiring polarization intensity when terahertz waves with which an object has been irradiated are transmitted through or reflected by the object; and
calculating tensile stress of the object based on the acquired polarization intensity.

### (Item 11A)

The program according to item 11, comprising a feature according to any one of the items above.

### Advantageous Effects of Invention

According to the present invention, the present invention can provide a method and the like for estimating the residual stress of an object, capable of quantitatively estimating the residual stress of the object.

### BRIEF DESCRIPTION OF DRAWINGS

FIG. 1 is a schematic diagram showing the concept of terahertz wave polarization measurement for a molded article.

FIG. 2 is a diagram showing an example of a configuration of a system 100 for quantitatively estimating the residual stress of an object.

FIG. 3 is a diagram showing an example of a configuration of a computer system 130.

FIG. 4 is a flowchart showing an example of a procedure 400 for quantitatively estimating the residual stress of an object.

FIG. 5 is a flowchart showing an example of processing 500 by a computer system for quantitatively estimating the residual stress of an object.

FIG. 6 is a graph of polarization intensity vs tensile stress.

FIG. 7 is a diagram showing three regions in the graph of FIG. 6.

FIG. 8 is (a) a graph of polarization intensity vs tensile stress and (b) a graph of tensile stress vs tensile distance.

FIG. 9 is a graph showing results of Example 1.

FIG. 10 is a graph showing results of Example 2.

### DESCRIPTION OF EMBODIMENTS

### Definition

As used herein, “terahertz wave” or “THz wave” means light with a wavelength of about 30 μm to about 1 mm. The “terahertz wave” or “THz wave” may be pulse-like light or continuous light.

As used herein, “polarization intensity of terahertz wave” means the degree of polarization received from a substance when the substance is irradiated with the terahertz wave. The “polarization intensity of terahertz wave” is measured from the terahertz waves transmitted through a substance or the terahertz waves reflected from the substance. The terahertz wave transmitted through a substance may be polarized according to the state inside the substance. The terahertz wave reflected from the substance may be polarized according to the state of the surface of the substance. When the terahertz waves do not transmit through any substance, the polarization intensity of the terahertz waves is zero.

As used herein, “tensile stress” refers to stress generated in a substance when a tensile force is applied to the substance.

As used herein, “tensile distance” refers to displacement in the direction of a tensile force when a tensile force is applied to a substance.

As used herein, “residual stress” refers to stress occurring inside a substance without any external force being applied to it. The residual stress typically occurs after an external force is applied to a substance and the external force is then removed. In the case of PTFE molded articles, for example, residual stress occurs due to the molding process or processing process of the PTFE molded articles.

As used herein, “object” refers to an object for which residual stress is estimated, and it is a substance having a fixed shape capable of transmitting terahertz waves. The “object” is typically a molded article, more specifically a resin molded article. The resin typically includes fluororesin, and the fluororesin may include, but is not limited to, for example, polytetrafluoroethylene (PTFE), perfluoroalkoxyalkane (PFA), ethylenetetrafluoroethylene copolymer (ETFE), perfluoroethylene propene copolymer (FEP), polyvinylidene fluoride (PVDF), polychlorotrifluoroethylene (PCTFE), ethylene chlorotrifluoroethylene copolymer (ECTFE), or a combination thereof. The resin may include, but is not limited to, polycarbonate (PC), polyacetal copolymer (POM), and the like.

As used herein, the term, “about”, means ±10% of the value that follows.

### Embodiments of the Present Invention

Hereinafter, embodiments of the present invention will be described with reference to the drawings.

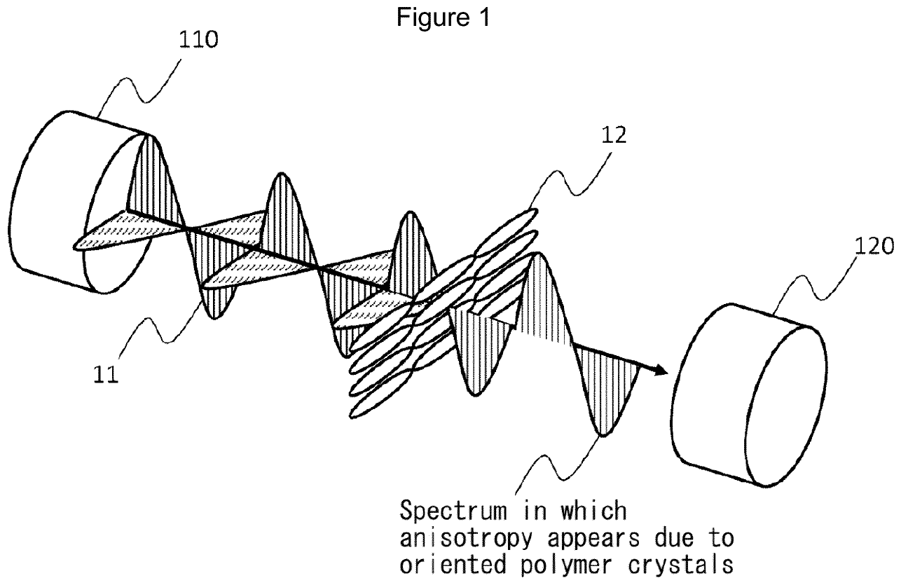

FIG. 1 schematically shows a concept of terahertz wave polarization measurement for an object.

Terahertz wave polarization measurement is performed using a terahertz wave light source 110 and a terahertz wave detector 120. The terahertz wave light source 110 is configured to emit terahertz waves, and the terahertz wave detector 120 is configured to detect the polarization intensity of the terahertz waves. An object is placed between the terahertz wave light source 110 and the terahertz wave detector 120, and the object is irradiated by terahertz waves 11 from the terahertz wave light source 110, followed by detecting the transmitted terahertz waves 11 with the terahertz wave detector 120, thereby to measure the polarization intensity of the terahertz waves from the object.

In the example shown in FIG. 1, polymer crystals 12 inside the object are shown schematically. As shown in FIG. 1, anisotropy appears in the spectrum of the terahertz waves 11 that have transmitted through the object when the polymer crystals 12 inside the object are oriented in a specific direction. This anisotropy is thought to be the cause of the polarization intensity of terahertz waves.

The inventors of the present invention have found that when there is residual stress in the object, the polymer crystals 12 inside the object change, and accordingly, the polarization intensity of the terahertz waves also change. The inventors of the present invention have also found that, since the residual stress of the object can be regarded as corresponding to the tensile stress of the object, the measurement of the polarization intensity of the object makes it possible to quantitatively estimate the tensile stress of the object based on the measured polarization intensity, and thus makes it possible to quantitatively estimate the residual stress.

In particular, the inventors of the present invention have invented a method capable of irradiating an object with terahertz waves, measuring the polarization intensity of the terahertz waves transmitted through or reflected by the object, and calculating the tensile stress or residual stress of the object based on the measured polarization intensity.

This method may be implemented by, for example, a system 100 for estimating the residual stress of an object, which will be described below.

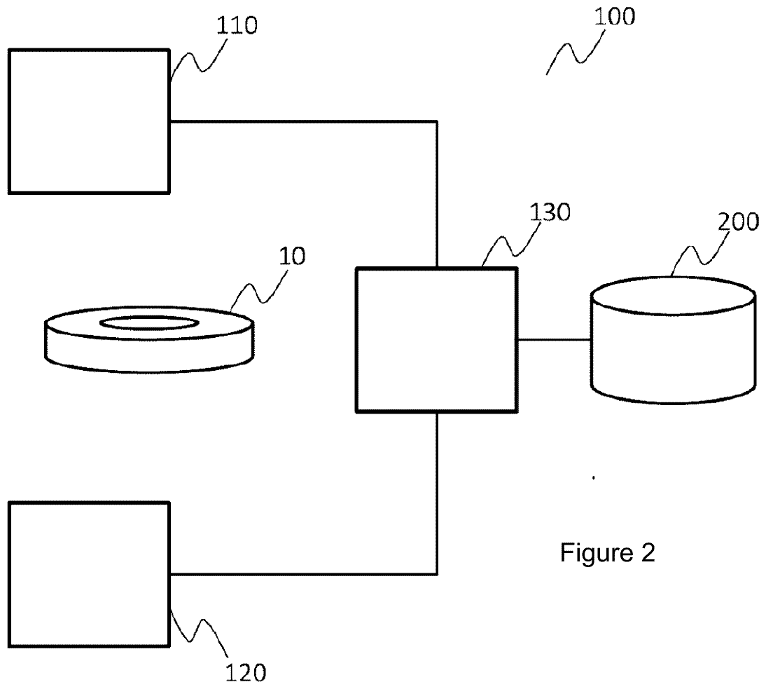

FIG. 2 shows an example of a configuration of a system 100 for estimating the residual stress of an object.

The system 100 is configured to be capable of irradiating an object 10 with terahertz waves, measuring the polarization intensity of terahertz waves transmitted through the object 10, and thereby calculating the tensile stress of the object 10. Since the tensile stress of the object can be regarded as corresponding to the residual stress of the object, the residual stress of the object can be quantitatively estimated by the system 100.

Any material may be used to form the object 10. For example, the material may be resin, and the resin may be such resin that produces residual stress inside when the resin is processed or when a load is applied thereto. Such resin includes, for example, fluororesin. Examples of the fluororesin may include, but are not limited to, polytetrafluoroethylene (PTFE), perfluorophenylalanine (PFA), tetrafluoroethylene-ethylene copolymer (ETFE), perfluoro ethylene propylene copolymer (FEP), polyvinylidene fluoride (PVDF), polychlorotrifluoroethylene (PCTFE), ethylene chlorotrifluoroethylene copolymer (ECTFE), or a combination thereof. An object 10 constituted of resin may be, for example, a resin molded article formed after having undergone machining. The machining or load application generates residual stress within the resin molded article 10. As to the material constituting the object 10, the present invention is not limited to this. For example, the material constituting the object may be metallic material, ceramic material, and a composite material thereof.

In the example shown in FIG. 2, the object 10 is shown as a solid, generally-circular member; however, the shape of the object 10 is not limited to this. The shape of the object 10 may be any shape. For example, the shape of the object 10, in the cross section thereof, may be generally elliptical, generally generally circular, (triangle, quadrangle, pentagon, hexagon, etc.), polygonal generally regular polygon (generally regular triangle, generally square, generally regular pentagon, generally regular hexagon, etc.), etc. Furthermore, the shape of the object 10 may be solid or hollow. When the shape is hollow, the shape of the hollow part may be any shape. For example, the hollow part may be generally circular, generally elliptical, generally polygonal (generally triangle, generally quadrangle, generally pentagon, generally hexagon, etc.), generally regular polygon (generally regular triangle, generally square, generally regular pentagon, generally regular hexagon, etc.), etc. Furthermore, the object may be a generally columnar body, a generally tubular body, or a generally flat plate.

The system 100 comprises a terahertz wave light source 110, a terahertz wave detector 120, and a computer system 130. The terahertz wave light source 110 and the terahertz wave detector 120 are each connected to the computer system 130. The present invention may take into consideration any connection modes of the terahertz wave light source 110 and the terahertz wave detector 120 with the computer system 130. For example, the terahertz wave light source 110 and the terahertz wave detector 120 may be connected with the computer system 130 by wire or wirelessly. For example, the terahertz wave light source 110 and the terahertz wave detector 120 may be connected with the computer system 130 through any network (e.g., the Internet, or a local area network).

The terahertz wave light source 110 may be any mechanism capable of emitting the terahertz wave. The terahertz wave light source 110 may be configured to be capable of emitting only THz waves having a specific frequency or a specific frequency band, for example. The specific frequency may be about zero to about 5.0 THz, etc. The terahertz wave light source 110 is configured to emit only the terahertz waves having a specific frequency, so that the terahertz wave light source 110 does not need to have a capability for emitting a wide range of terahertz waves, which can simplify the structure of the terahertz wave light source 110. This leads to lowering of the cost for the system 100.

The terahertz waves emitted from the terahertz wave light source 110 transmit through the object 10 and reach the terahertz wave detector 120.

The terahertz wave detector 120 may be any mechanism configured to detect terahertz waves. The terahertz wave detector 120 can be configured to measure the polarization intensity of the terahertz waves. The terahertz wave detector 120 can output the polarization intensity of the detected terahertz waves as a voltage signal, for example.

The computer system 130 is further configured to calculate the tensile stress of the object, based on the polarization intensity of the terahertz waves measured by the terahertz wave detector 120 from the terahertz waves with which the object 10 have been irradiated.

The system 100 may further be equipped with a work turntable for changing the positions on the object 10 that are irradiated with the terahertz waves. A spot exists on the work turntable, and the spot is irradiated with terahertz waves from the terahertz wave light source 110. The positional relationship between the terahertz wave light source 110 and the work turntable is fixed, and thus, the rotating of the work turntable can change the orientation about the optical axis for the object 10 that is irradiated with the terahertz waves. The terahertz waves have directions in which the electric field vector and the magnetic field vector oscillate, and along with the changing of the orientation about the optical axis for the object 10 that is irradiated with the terahertz waves, the oscillation directions of the electric field vector and the magnetic field vector of the terahertz waves on the object 10 can also be changed. Furthermore, changing the positions and/or orientations of the object 10 relative to the work turntable can also change the irradiation positions on the object 10 that are irradiated with the terahertz waves.

The computer system 130 may be connected to a database unit 200.

The database unit 200 may store results of terahertz wave polarization intensity measurements performed in the past. Specifically, the results of terahertz wave polarization intensity measurements performed on objects under various tensile distance conditions may be stored in association with the respective tensile distance conditions.

In addition, the database unit 200 may store results of tensile stress measurements. Specifically, the results of tensile stress measurements performed on objects under various tensile distance conditions may be stored in association with the respective tensile distance conditions.

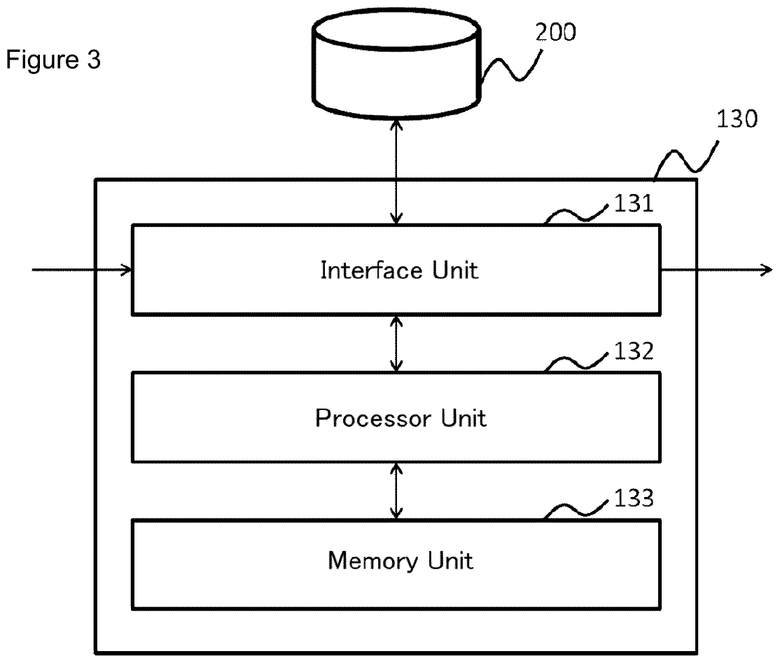

FIG. 3 shows an example of a configuration of a computer system 130.

The computer system 130 comprises an interface unit 131, a processor unit 132, and a memory unit 133.

The interface unit 131 exchanges information with the outside of the computer system 130. The processor unit 132 of the computer system 130 is capable of receiving information from the outside of the computer system 130 and is also capable of transmitting information to the outside of the computer system 130, via the interface unit 131. The interface unit 131 can exchange information in any format.

The interface unit 131 can receive output signals from the terahertz wave detector 120. The interface unit 131 can output, to the outside of the computer system 130, the calculated quantitative value of the tensile stress or the estimated quantitative value of the residual stress.

The interface unit 131 comprises, for example, an input unit that enables information to be input into the computer system 130. Any modes may be taken into consideration for the input unit to enable information to be input into the computer system 130. For example, if the input unit is a touch panel, the user may input information by touching the touch panel. Alternatively, if the input unit is a mouse, the user may input the information by operating the mouse. Alternatively, if the input unit is a keyboard, the user may enter information by pressing the keys on the keyboard. Alternatively, if the input unit is a microphone, the user may input information by inputting voice into the microphone. Alternatively, if the input unit is a data reader, the information may be input by reading the information from the storage medium connected to the computer system 130. Alternatively, if the input unit is a receiver, the receiver may receive information from the outside of the computer system 130 via the network thereby to input the information.

The interface unit comprises, for example, an output unit that enables information to be output from the computer system 130. Any modes may be taken into consideration for the output unit to enable information to be output from the computer system 130. For example, if the output unit is a display screen, the information may be output on the display screen. Alternatively, if the output unit is a speaker, the information may be output by the voice from the speaker. Alternatively, if the output unit is a data writer, the information may be output by writing the information onto the storage medium connected to the computer system 130. Alternatively, if the output unit is a transmitter, the information may be output by the transmitter transmitting the information to the outside of the computer system 130 via the network.

The processor unit 132 executes the processing of the computer system 130 and controls the operation of the entire computer system 130. The processor unit 132 reads the program stored in the memory unit 133 and executes the program. This allows the computer system 130 to function as a system that executes desired steps. The processor unit 132 may be implemented by a single processor or by plurality of processors. Here, the plurality of processors may be located in the same hardware component, or may be located in separate hardware components in the vicinity or remote.

The processor unit 132 can acquire the polarization intensity of the terahertz waves received from the terahertz wave detector 120 via the interface unit 131. Alternatively, the processor unit 132 may derive the polarization intensity of the terahertz waves by analyzing the output signal received from the terahertz wave detector 120 via the interface unit 131.

The processor unit 132 is configured to calculate the tensile stress of the object based on the measured polarization intensity. For example, the processor unit 132 can calculate the tensile stress based on the relationship between polarization intensity and tensile stress derived from the relationship between polarization intensity and tensile distance and the relationship between tensile distance and tensile stress.

Specifically, the processor unit 132 can calculate the tensile stress by comparing the measured polarization intensity with the relationship between polarization intensity and tensile stress. Regarding the relationship between polarization intensity and tensile stress, for example, when the function of (tensile stress)=f (polarization intensity) is derived, the measured polarization intensity is substituted into this function so that the tensile stress can be calculated. Alternatively, when a graph of polarization intensity vs tensile stress is derived, the measured polarization intensity is plotted on the graph so that the tensile stress can be calculated.

Here, the relationship between polarization intensity and tensile stress may be acquired by: (1) acquiring the relationship between polarization intensity and tensile distance; (2) acquiring the relationship between tensile distance and tensile stress; and (3) combining the relationship between polarization intensity and tensile distance with the relationship between tensile distance and tensile stress, via the tensile distance, thereby deriving the relationship between polarization intensity and tensile stress. The processor unit 132 can, for example, acquire the relationship between polarization intensity and tensile distance and the relationship between tensile distance and tensile stress from the database unit 200, and combine them via the tensile distance.

For example, when the relationship between polarization intensity and tensile distance is expressed by a graph of polarization VS intensity tensile stress and the relationship between tensile distance and tensile stress is expressed by a graph of tensile stress vs tensile distance, the axes of these graphs are combined to integrate so that a graph of polarization intensity vs tensile stress can be derived.

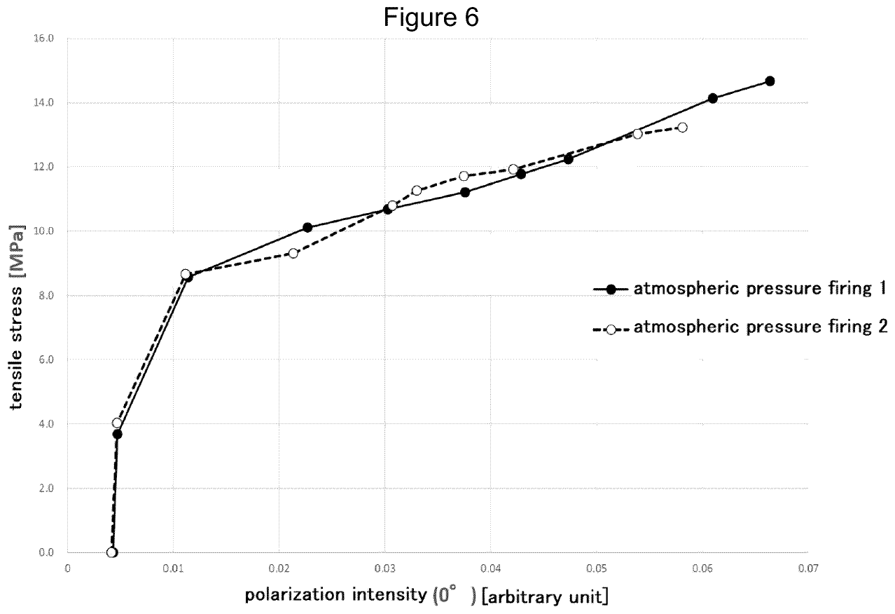

For example, a graph of polarization intensity vs tensile stress is derived, as shown in FIG. 6. FIG. 6 is a graph acquired from the results of polarization intensity vs tensile stress and the results of tensile stress vs tensile distance, acquired from experiments conducted on two PTFE molded articles fired under atmospheric pressure.

The processor unit 132 can calculate the tensile stress by comparing the measured polarization intensity with the graph.

For example, when the relationship between polarization intensity and distance tensile is expressed by a function of:

(tensile distance)=f(polarization intensity) (i); and
when the relationship between tensile distance and tensile stress is expressed by a function of:

(tensile stress)=f(tensile distance) (ii),
(i) is substituted into (ii) so that a function of (tensile stress)=f (polarization intensity) can be derived.

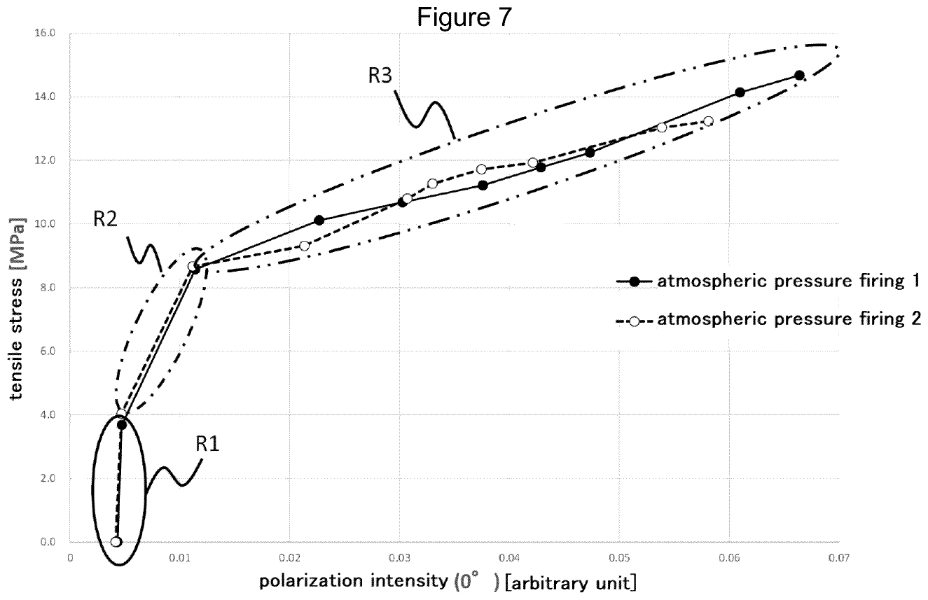

For example, as shown in FIG. 7, which shows the same graph as FIG. 6, the graph is divided into three regions (the first region R1, the second region R2, and the third region R3), and a function expressing the relationship between tensile stress and polarization intensity can be derived for each region. For example, the following can be derived:
as for R1, tensile stress≈a (where a is a constant);
as for R2, tensile stress=bx+c (where b and c are constants; and in the example shown in FIG. 7, b=730, and c=0.5); and
as for R3, tensile stress=dx+e (where d and e are constants).

For example, R1 is a region of proportional elastic deformation, R2 is a region of elastic deformation (i.e., elastic region), and R3 is a region of plastic deformation (i.e., plastic region). The processor unit 132 can, for example, determine in which region the object is located based on the measured polarization intensity, and calculate the tensile stress by using the function of the determined region.

Note that the three regions mentioned above are mere examples, and the function may be derived for one region without dividing the region, or the function may be derived for each region while dividing the region into more than three regions. It is preferable to change the number of divisions according to the physical properties of substance determined to be the object.

For example, it is preferable to divide a region into two (i.e., an elastic region and a plastic region). This is because a substance deforms differently between an elastic region and a plastic region. The processor unit 132 can determine whether the object is in the elastic region or the plastic region based on the measured polarization intensity. When the object is determined to be in the elastic region, the processor unit 132 can calculate the tensile stress based on the relationship between the polarization intensity and tensile stress of the object in the elastic region; and when the object is determined to be in the plastic region, the processor unit 132 can calculate the tensile stress based on the relationship between the polarization intensity and tensile stress of the object in the plastic region.

In another example, the processor unit 132 may first identify the tensile distance corresponding to the measured polarization intensity by comparing the measured polarization intensity with the known relationship between the polarization intensity and the tensile distance, and the processor unit 132 may then identify the tensile stress corresponding to the identified tensile distance by comparing the identified tensile distance with the known relationship between the tensile distance and the tensile stress.

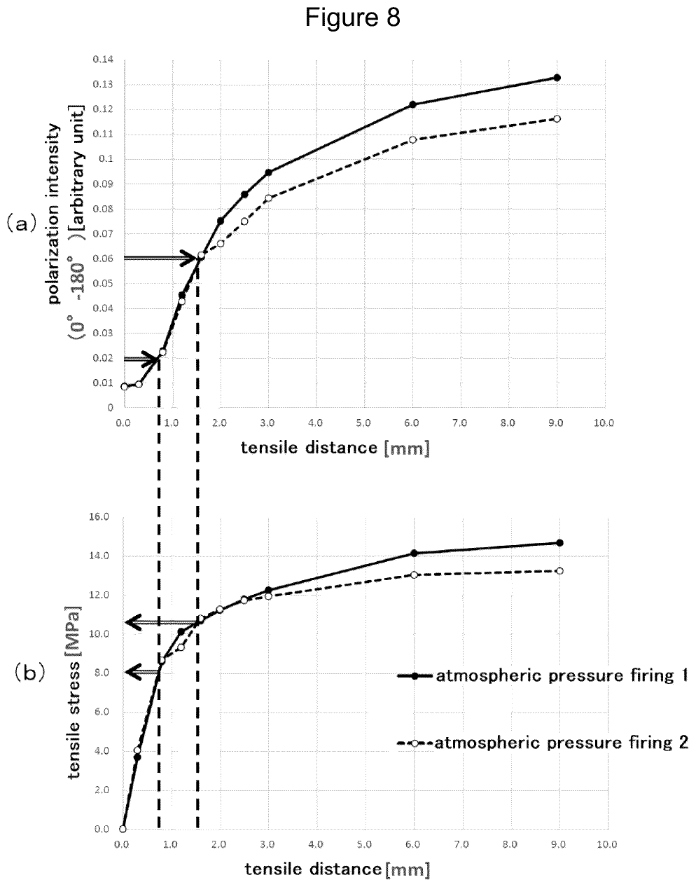

For example, a graph of polarization intensity vs tensile stress is derived as shown in FIG. 8(a), and a graph of tensile stress vs tensile distance is derived as shown in FIG. 8(b). FIG. 8(a) and FIG. 8(b) are graphs acquired from experiments performed on two PTFE molded articles fired under atmospheric pressure.

The processor unit 132 can compare the measured polarization intensity with the graph of FIG. 8(a) to identify a corresponding tensile distance and can compare the identified tensile distance with the graph of FIG. 8(b) to calculate a corresponding tensile stress.

For example, if the measured polarization intensity is about 0.06 as indicated by the upper arrow, then the corresponding tensile distance is about 1.5 mm, and therefore, the tensile stress corresponding to about 1.5 mm can be calculated to be about 12.0 MPa.

For example, if the measured polarization intensity is about 0.02 as indicated by the lower arrow, then the corresponding tensile distance is about 0.8 mm, and therefore, the tensile stress corresponding to about 0.8 mm can be calculated to be about 8.0 MPa.

In this way, the processor unit 132 can calculate the tensile stress of the object. As to the tensile stress of an object, when the tensile stress is calculated at the time of measuring the polarization intensity when no tensile force is applied, it can be regarded as the residual stress of the object. That is, the processor unit 132 is capable of quantitatively estimating the residual stress of the object.

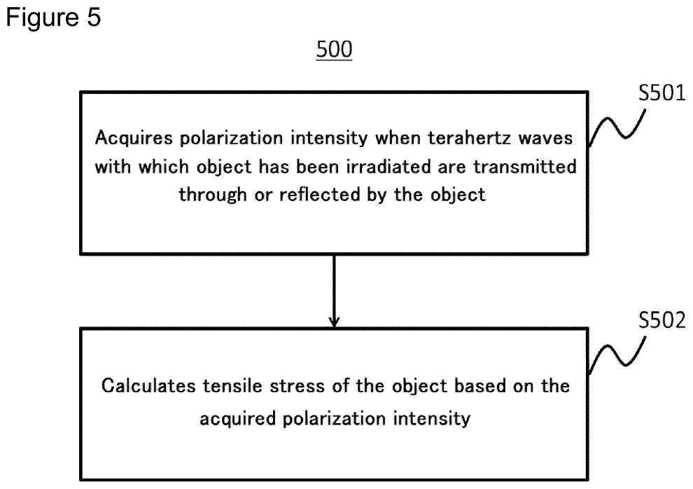

The memory unit 133 stores the program required to execute the processing of the computer system 130, the data required to execute the program, and the like. The memory unit 133 may store a program for causing the processor unit 132 to perform processing for estimating the residual stress of the object (e.g., the program for enabling the processing shown in FIG. 5 described below). Herein, any means may be taken into consideration for the way of storing the program onto the memory unit 133. For example, the program may be pre-installed in the memory unit 133. Alternatively, the program may be installed in the memory unit 133 by being downloaded via the network. Alternatively, the program may be stored on a non-transitory computer-readable storage medium and installed by reading program from the medium. The memory unit 133 may be implemented by any storage means.

The database unit 200 may store results of terahertz wave polarization intensity measurements performed in the past. Alternatively, the database unit 200 may store results of analyzing g the results of the terahertz wave polarization intensity measurements performed in the past.

For example, the database unit 200 stores: the polarization intensity measured by the terahertz wave detector 120; and the tensile distance of the object 10 at that time, in association with each other. Storing the polarization intensity for various tensile distances in the database unit 200 makes it possible to obtain the relationship between polarization intensity and tensile distance.

When measuring the polarization intensity with respect to various tensile distances, it is preferable to fix the orientation of the measurement object around the optical axis. This is because, as to substances, especially substances formed from polymeric materials, if the orientation around the optical axis changes, the polarization intensity will also change due to the direction of orientation of the polymer crystals, causing noise in the measurement results, even if the same location on a substance is irradiated with terahertz waves. Therefore, the relationship between the polarization intensity and the tensile distance is preferably established by (1) fixing the orientation around the optical axis and irradiating an object with the terahertz waves under various tensile distance conditions, and (2) measuring the polarization intensity under various tensile distance conditions.

In addition, the results of tensile stress measurements may be stored in the database unit 200. Specifically, the results of tensile stress measurements performed on objects under various tensile distance conditions may be stored in association with the respective tensile distance conditions.

For example, in the database unit 200, the tensile stress measured by a tensile stress measuring device and the tensile distance of the object 10 at that time are stored in association with each other. The tensile stress measuring device may be, for example, a MicroTEST tensile tester (MT5000DL) manufactured by DEBEN, UK. Storing the tensile stress with respect to various tensile distances in the database unit 200 makes it possible to acquire the relationship between the tensile distance and the tensile stress.

By utilizing the data stored in the database unit 200, the processor unit 132 can derive the relationship between polarization intensity and tensile stress, from the relationship between polarization intensity and tensile distance and the relationship between tensile distance and tensile stress. For example, the relationship between polarization intensity and tensile stress can be derived as described above with reference to FIGS. 6 to 8.

While the measurement of the polarization intensity of the terahertz waves by detecting the terahertz wave transmitted through the object 10 using the terahertz wave detector 120 is described in the above example, the present invention is not limited to this. Also within the scope of the present invention is the measurement of the polarization intensity of the terahertz waves by detecting the terahertz waves reflected from the object 10 using the terahertz wave detector. The terahertz wave detector for detecting the terahertz waves reflected from the object 10 may have a configuration similar to that of the terahertz wave detector 120 for detecting the terahertz waves transmitted through the object 10.

While the database unit 200 is provided outside the computer system 130 in the examples shown in FIGS. 2 and 3, the present invention is not limited to this. It is also possible to provide at least part of the database unit 200 inside the computer system 130. In such a configuration, at least part of the database unit 200 may be implemented by the same storage means as the storage means for implementing the memory unit 133, or it may be implemented by a storage means different from the storage means for implementing the memory unit 133. In any case, at least part of the database unit 200 is configured as a storage unit for the computer system 130. The configuration of the database unit 200 is not limited to a specific hardware configuration. For example, the database unit 200 may be composed of a single hardware component or may be composed of a plurality of hardware components. For example, the database unit 200 may be configured as an external hard disk device of the system 100 or may be configured as a storage on a cloud connected via a network.

Note that each constituent element of the computer system 130 may be composed of a single hardware component or may be composed of a plurality of hardware components. When each constituent element is composed of a plurality of hardware components, any modes may be taken into consideration for connecting respective hardware components. The respective hardware components may be connected wirelessly or by wire with each other. The computer system 130 is not limited to a specific hardware configuration. Also within the scope of the present invention is a configuration of the processor unit 132 with an analog circuit instead of a digital circuit. The configuration of the system 100 of the present invention is not limited to such a configuration as described above, and any configurations that can achieve the functions thereof may be used.

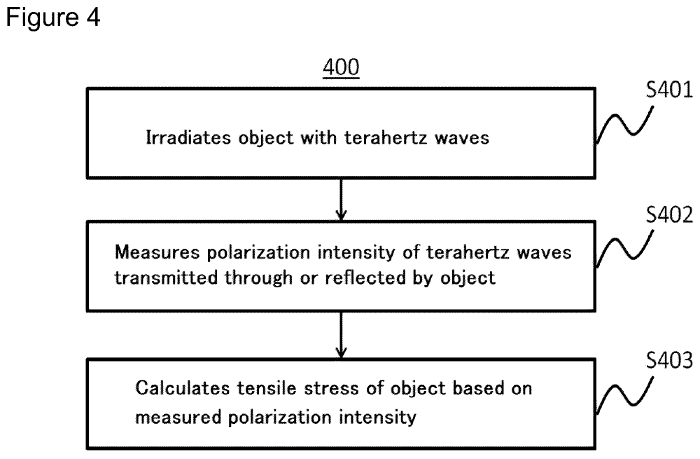

FIG. 4 shows an example of a procedure 400 for estimating the residual stress of an object. The procedure 400 is performed using the system 100.

In step S401, the object is irradiated with terahertz waves. For example, the object is placed on a work turntable, and the object is irradiated with terahertz waves from the terahertz wave light source 110.

In step S402, the polarization intensity of the terahertz wave transmitted through or reflected by the object is measured. For example, the terahertz wave detector 120 measures the polarization intensity of the terahertz waves transmitted through or reflected by the object. The terahertz wave detector 120 can output, for example, the polarization intensity of the detected terahertz wave as a voltage signal. The measured polarization intensity of the terahertz wave is passed to the computer system 130.

In step S403, the tensile stress of the object is calculated based on the measured polarization intensity. The computer system 130 calculates the tensile stress of the object based on the measured polarization intensity. For example, the tensile stress can be calculated by processing 500 described below with reference to FIG. 5.

If no external force is applied to the object, the calculated tensile stress can be regarded as the residual stress of the object. Therefore, according to the procedure 400, the tensile stress and furthermore the residual stress can be quantitatively estimated in a non-destructive manner.

FIG. 5 shows an example of processing 500 by a computer system for estimating the residual stress of the object. The processing 500 is performed in the processor unit 132 of the computer system 130.

In step S501, the processor unit 132 acquires the polarization intensity when the terahertz waves with which the object has been irradiated are transmitted through or reflected by the object, via an interface unit 131. The acquired polarization intensity is the polarization intensity measured in step S402 described above with reference to FIG. 4.

The processor unit 132 can acquire the polarization intensity received from the terahertz wave detector 120 via the interface unit 131. Alternatively, the processor unit 132 can acquire the polarization intensity received from the database unit 200 via the interface unit 131.

In step S502, the processor unit 132 calculates the tensile stress of the object based on the polarization intensity acquired in step S501. The tensile stress can be calculated based on relationship the between the polarization intensity and the tensile stress derived from: the relationship between the polarization intensity and the tensile distance; and the relationship between the tensile distance and the tensile stress. The relationship between the polarization intensity and the tensile stress is stored in, for example, the database unit 200, and the processor unit 132 can calculate the tensile stress by referring to the database unit 200.

For example, the processor unit 132 can calculate the tensile stress by substituting the polarization intensity acquired in step S501 into a function indicating the relationship between the polarization intensity and the tensile stress. Alternatively, the processor unit 132 can calculate the tensile stress by plotting the polarization intensity acquired in step S501 on a graph showing the relationship between the polarization intensity and the tensile stress.

Alternatively, the processor unit 132 can first identify the tensile distance corresponding to the polarization intensity acquired in step S501 based on the relationship between the polarization intensity and the tensile distance, and then identify the tensile stress corresponding to the identified tensile distance based on the relationship between the tensile distance and the tensile stress.

While the processing of each step shown in FIG. 5 is described to be achieved by the processor unit 132 and the program stored in the memory unit 133 in the example described above with reference to FIG. 5, the present invention is not limited to this. At least one of the processes in the steps shown in FIG. 5 may be achieved by a hardware configuration, such as a control circuit.

### EXAMPLES

### Example 1

With the use of a plurality of PTFE molded articles, the relationship between polarization intensity and tensile stress was derived.

Eleven samples were used as the plurality of PTFE molded articles. Nine samples (Sample 1, and Samples 4 to 11) were fired under the same atmospheric pressure conditions, and two samples (Sample 2, and Sample 3) were fired under pressure conditions, where Sample 2 was such a sample that was fired under a pressure of 5 MPa, while Sample 3 was such a sample that was fired under a pressure of 10 MPa.

Each of the samples was irradiated with terahertz waves, followed by conducting an experiment for measuring the polarization intensity of the transmitted terahertz waves and an experiment for measuring the tensile stress.

In the experiments, each sample was mounted on a tensile tester, and as the tensile distance was gradually increased, the polarization intensity and tensile stress were measured at tensile distances of 0 mm, 0.3 mm, 0.8 mm, 1.2 mm, 1.6 mm, 2 mm, 2.5 mm, 3 mm, 6 mm, and 9 mm, respectively.

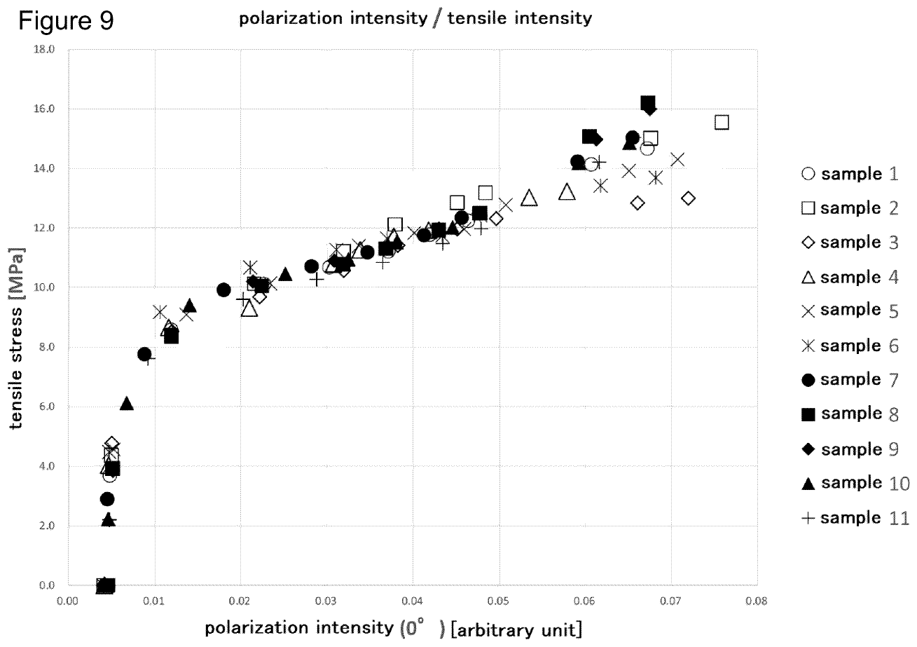

FIG. 9 is a graph showing the results.

The same tendency was observed in all the samples, including samples with different firing conditions. That is, in the region where the polarization intensity was small, the tensile stress rapidly increased, whereas in the region where the polarization intensity was large, the polarization intensity and the tensile stress were in a proportional relationship.

What can be seen from the above is the suggestion that: for PTFE molded articles, experimental results acquired in advance are utilized, and such a molded article with unknown residual stress is irradiated with terahertz waves and the polarization intensity thereof is measured, stress to be estimated in a non-allowing the residual destructive manner.

### Example 2

In the above-mentioned example, the present invention has been described with an example of PTFE used therein as an object; however, the object is not limited to this. The object may be an object having any fixed shape that can transmit terahertz waves, and typically may be a resin.

In order to confirm that resins exhibit a similar tendency, the relationship between polarization intensity and tensile stress was derived using molded articles of polycarbonate (PC) and polyacetal copolymer (POM) as representative resins.

Each of the samples was irradiated with terahertz waves, followed by conducting an experiment for measuring the polarization intensity of the transmitted terahertz waves and an experiment for measuring the tensile stress.

In the experiments, each sample was mounted on tensile tester, and as the tensile distance was gradually increased, the polarization intensity and tensile stress were measured at tensile distances of 0 mm, 0.3 mm, 0.6 mm, 0.8 mm, 1.2 mm, 1.6 mm, 2 mm, 2.5 mm, 3 mm, and 6 mm, respectively.

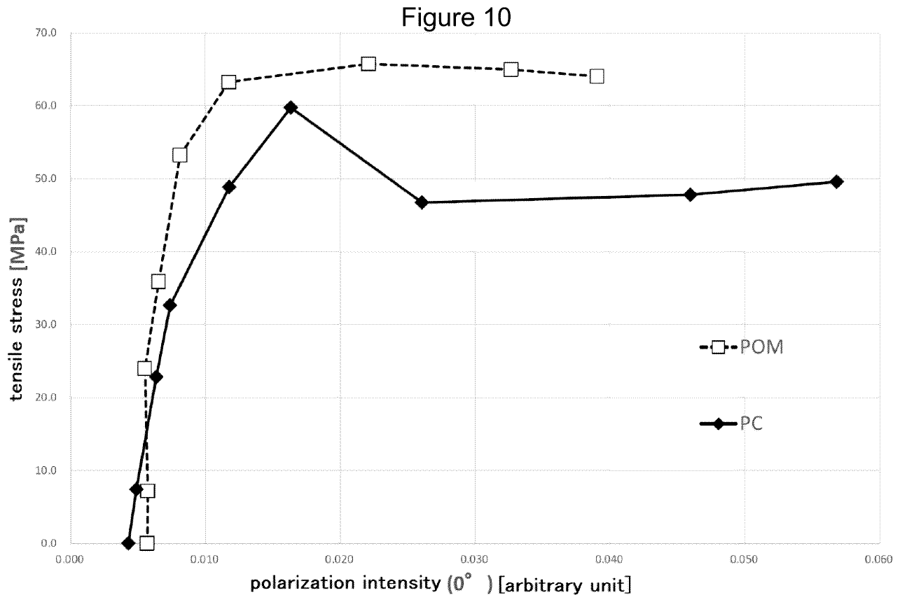

FIG. 10 is a graph showing the results.

A similar tendency was observed in molded articles made of different materials as well. That is, in the region where the polarization intensity was small, the tensile stress rapidly increased, whereas in the region where the polarization intensity was large, the polarization intensity and the tensile stress were in a proportional relationship.

The present invention is not limited to the above-described embodiments. It is understood that the present invention should be construed only by the claims. It is understood that those skilled in the art can implement an equivalent scope from the description of the specific preferred embodiments of the present invention based on the description of the present invention and common general knowledge.

### INDUSTRIAL APPLICABILITY

The present invention is advantageous in that it can provide a method and the like for estimating the residual stress of an object.

### DESCRIPTION OF REFERENCE NUMERALS

11 terahertz waves
12 polymer crystal
100 system
110 terahertz wave light source
120 terahertz wave detector
130 computer system
200 database unit

1. A method for estimating residual stress of an object, the method comprising:
acquiring polarization intensity when terahertz waves with which an object has been irradiated are transmitted through or reflected by the object; and
calculating tensile stress of the object based on the acquired polarization intensity.

2. The method according to claim 1, wherein acquiring the polarization intensity comprises:
irradiating the object with terahertz waves; and
measuring polarization intensity of the terahertz waves transmitted through or reflected by the object.

3. The method according to claim 1, wherein calculating the tensile stress comprises calculating the tensile stress based on a relationship between polarization intensity and tensile stress derived from: a relationship between polarization intensity and tensile distance; and a relationship between tensile distance and tensile stress.

4. The method according to claim 3, wherein the relationship between polarization intensity and tensile stress is acquired by:
acquiring the relationship between polarization intensity and tensile distance;
acquiring the relationship between tensile distance and tensile stress; and
combining the relationship between polarization intensity and tensile distance with the relationship between tensile distance and tensile stress, via the tensile distance, to derive the relationship between polarization intensity and tensile stress.

5. The method according to claim 4, wherein acquiring the relationship between polarization intensity and tensile distance comprises:
fixing an orientation around an optical axis and irradiating the object with the terahertz waves under various tensile distance conditions;
measuring polarization intensity under the various tensile distance conditions; and
acquiring a relationship between the polarization intensity and a tensile distance associated with the polarization intensity.

6. The method according to claim 3, wherein calculating the tensile stress comprises:
determining whether the object is in an elastic region or in a plastic region based on the polarization intensity;
when the object is in the elastic region, calculating the tensile stress based on a relationship between polarization intensity and tensile stress of the object in the elastic region; and
when the object is in the plastic region, calculating the tensile stress based on a relationship between polarization intensity and tensile stress of the object in the plastic region.

7. The method according to claim 1, wherein the object includes a resin.

8. The method according to claim 7, wherein the resin includes polytetrafluoroethylene (PTFE).

9. A system for estimating residual stress of an object, the system comprising a processor configured to:
acquire polarization intensity when terahertz waves with which an object has been irradiated are transmitted through or reflected by the object; and
calculate tensile stress of the object based on the acquired polarization intensity.

10. The system according to claim 9, further comprising:
a terahertz wave light source for irradiating the object with terahertz waves;
a terahertz wave detector for measuring polarization intensity of the terahertz waves transmitted through or reflected by the object.

11. A non-transitory computer-readable storage medium storing a program for estimating residual stress of an object, the program being executed by a computer system comprising a processor, the program causing the processor to execute processing comprising:
acquiring polarization intensity when terahertz waves with which an object has been irradiated are transmitted through or reflected by the object; and
calculating tensile stress of the object based on the acquired polarization intensity.
